(19) United States
(12) Patent Application Publication
(10) Pub. No.: US 2020/0091843 A1
(43) Pub. Date: Mar. 19, 2020

(54) MOTOR CONTROL DEVICE AND MOTOR CONTROL METHOD

(71) Applicants: Kabushiki Kaisha Toshiba, Tokyo (JP); Toshiba Electronic Devices & Storage Corporation, Tokyo (JP)

(72) Inventor: Masatoshi Matsuda, Yokohama Kanagawa (JP)

(21) Appl. No.: 16/351,914

(22) Filed: Mar. 13, 2019

(30) Foreign Application Priority Data
Sep. 18, 2018 (JP) 2018-174250

(51) Int. Cl. H02P 6/15

(52) U.S. Cl. CPC H02P 6/153; H02K 29/08

(57) ABSTRACT

According to one embodiment, a motor control device controls a brushless motor including a rotor with a magnet, and a stator including multi-phase wound coils. In the motor control device, a rotational-direction detector detects a rotational direction of the brushless motor, in accordance with a hall signal detected by a hall-signal detector and a phase current detected by a phase-current detector at timing when at least one transistor is set in an energizable state.

### CROSS-REFERENCE TO RELATED APPLICATIONS

This application is based upon and claims the benefit of priority from Japanese Patent Application No. 2018-174250, filed Sep. 18, 2018, the entire contents of which are incorporated herein by reference.

### FIELD

Embodiments described herein relate generally to a motor control device and a motor control method.

### BACKGROUND

In recent years, brushless motors including a rotor with a magnet such as a permanent magnet, and a multi-phase (for example, three) coil-wound stator, have been widely used. To detect a rotational direction of a brushless motor with two or more hall elements (with phase difference other than 180° in the case of two hall elements), for example, the rotational direction of the brushless motor is easily detectable in accordance with two or more hall signals.

However, a detecting method with a simple configuration for the rotational direction of the brushless motor with only one hall element and only one hall signal is not available.

An object of one embodiment is to provide a motor control device with a simple configuration and a motor control method which enable detection of the rotational direction of a brushless motor having only one hall signal.

### BRIEF DESCRIPTION OF THE DRAWINGS

FIG. 1 is a diagram illustrating a configuration of a motor control device according to a first embodiment;

FIG. 2 is a diagram illustrating the configuration of the motor control device according to the first embodiment;

FIG. 3 is a diagram illustrating a configuration of a phase-current detector circuit on a low potential side in the first embodiment;

FIG. 4 is a diagram illustrating a configuration of a phase-current detector circuit on a high potential side in the first embodiment;

FIG. 5A is a timing chart illustrating a variation in each signal during a forward rotation of a motor in the first embodiment;

FIG. 5B is a timing chart illustrating a variation in each signal during a reverse rotation of the motor in the first embodiment;

FIG. 6 is a flowchart illustrating the operation of the motor control device according to the first embodiment;

FIG. 7 is a relationship diagram of signal detection in the first embodiment;

FIG. 8A is a timing chart illustrating a variation in each signal during a forward rotation of a motor in a second embodiment;

FIG. 8B is a timing chart illustrating a variation in each signal during a reverse rotation of the motor in the second embodiment;

FIG. 9 is a diagram illustrating a configuration of a phase-current detector circuit on a low potential side in a third embodiment;

FIG. 10 is a diagram illustrating a configuration of a phase-current detector circuit on a high potential side in the third embodiment;

FIG. 11A is a timing chart illustrating a variation in each signal during a forward rotation of a motor in the third embodiment;

FIG. 11B is a timing chart illustrating a variation in each signal during a reverse rotation of the motor in the third embodiment; and

FIG. 12 is a relationship diagram of signal detection in the third embodiment.

### DETAILED DESCRIPTION

According to one embodiment, in general, a motor control device controls a brushless motor including a rotor with a magnet, and a stator including multi-phase wound coils. The device includes a power device, a hall-signal detector, a power-device controller, a phase-current detector, and a rotational-direction detector. The power device includes a plurality of transistors, and supplies power to the brushless motor. The hall-signal detector detects a hall signal from one hall element of the brushless motor. The power-device controller sets at least one of the transistors in an energizable state for a certain period at certain timing during rotation of the brushless motor. The phase-current detector detects a phase current flowing through the at least one transistor in the energizable state. The rotational-direction detector detects a rotational direction of the brushless motor, in accordance with the hall signal and the detected phase current at timing in the energizable state of at least one transistor.

A motor control device and a motor control method according to a first embodiment to a third embodiment will be explained below in detail with reference to the accompanying drawings. The following embodiments are not intended to limit the present invention.

### First Embodiment

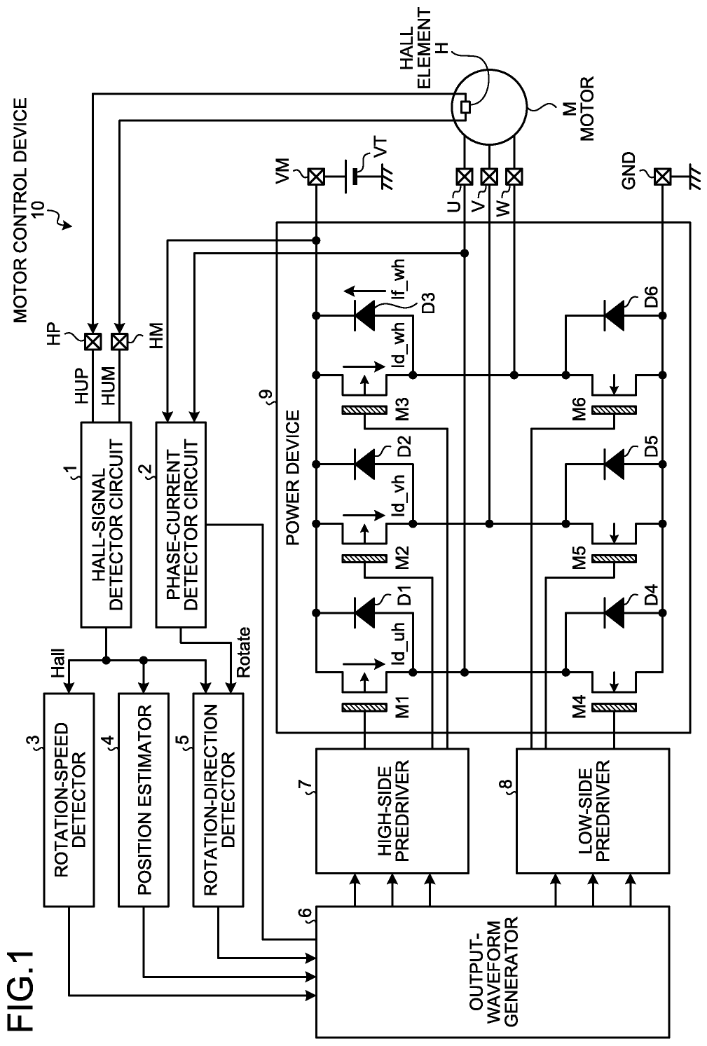

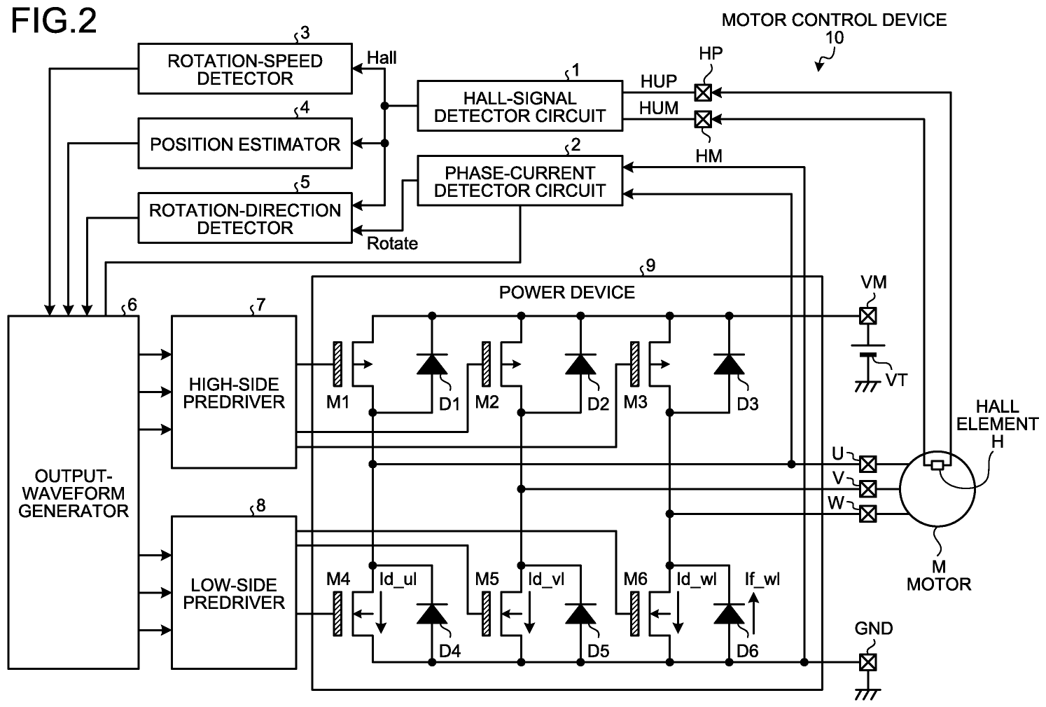

FIG. 1 and FIG. 2 are diagrams illustrating the configuration of a motor control device 10 according to a first embodiment. FIG. 1 is an explanatory diagram of a high potential side of a power device 9. FIG. 2 is an explanatory diagram of a low potential side of the power device 9.

The motor control device 10 controls a motor M being a brushless motor. The motor M includes a rotor with a magnet such as a permanent magnet, and a stator including three-phase wound coils. The three phases are a U phase, a V phase, and a W phase with a phase difference 120°, for example. The motor M also includes one hall element H placed on the U-phase coil.

Specifically, the motor control device 10 includes a power source VT, a power device 9, a hall-signal detector circuit 1 (hall-signal detector), a phase-current detector circuit 2 (phase-current detector), a rotation-speed detector 3, a position estimator 4, a rotational-direction detector 5, an output-waveform generator 6, a high-side predriver 7 (power-device controller), and a low-side predriver 8 (power-device controller). The power source VT is connected between a motor power applying terminal VM and the ground to output a power supply voltage.

The power device 9 includes a plurality of transistors (for example, an nMOS transistor), and is connected between the motor power applying terminal VM and a ground terminal GND or the ground. The power device 9 supplies the power supply voltage to the motor M through U, V, and W-terminals as three-phase sine wave signals. Specifically, the power device 9 includes six transistors M1 to M6 and six diodes D1 to D6 (for example, a parasitic diode, a flywheel diode) corresponding to the six transistors M1 to M6.

For example, the diode D1 is connected at a cathode and an anode to a drain and a source of the transistor M1, respectively. The diodes D2 to D6 are connected to the transistors M2 to M6 in the same manner. Supplied with the three-phase sine wave signals from the power device 9, a current flows through the three-phase coil, thereby driving the motor.

The hall-signal detector circuit 1 detects a hall signal HUP (Hall Output+U-Phase Terminal), a hall signal HUM (Hall Output−U-Phase Terminal), and an inverse signal of HUP) from the hall element H through terminals HP and HM, respectively, and outputs a U-phase hall detection signal Hall. The U-phase hall detection signal turns to HIGH when the hall signal HUP is larger than the hall signal HUM, and turns to LOW (GND) when the hall signal HUP is smaller than the hall signal HUM.

The phase-current detector circuit 2 detects a phase current flowing through each of the three U, V, and W-phase coils, and outputs a phase current detection signal Rotate. For example, while at least one transistor is placed in an energizable state, the phase-current detector circuit 2 detects the phase current flowing through this transistor.

The rotation-speed detector 3 detects the rotation speed of the motor M from the U-phase hall detection signal Hall from the hall-signal detector circuit 1, and outputs a signal according to a result of the detection.

The position estimator 4 estimates the position of the motor M in accordance with the U-phase hall detection signal Hall from the hall-signal detector circuit 1, and outputs a signal according to a result of the estimation.

The rotational-direction detector 5 detects a rotational direction of the motor M in accordance with the U-phase hall detection signal Hall from the hall-signal detector circuit 1 and the phase current detection signal Rotate from the phase-current detector circuit 2 at timing in the energizable state of the at least one transistor, and outputs a signal according to a result of the detecting.

The output-waveform generator 6 receives the signal according to the detection result of the rotation-speed detector 3, the signal according to the estimated result of the position estimator 4, and the signal according to the detecting result of the rotational-direction detector 5, to generate and output an output waveform.

The high-side predriver 7 controls a high potential side of the power device 9, i.e., the transistors M1 to M3, in accordance with the output waveform from the output-waveform generator 6, for example, by switching ON and OFF of the switching element.

The low-side predriver 8 controls a low potential side of the power device 9, i.e., the transistors M4 to M6, in accordance with the output waveform from the output-waveform generator 6, for example, by switching ON and OFF of the switching element.

In addition, the high-side predriver 7 and the low-side predriver 8 can set at least one of the transistors M1 to M6 in the energizable state at certain timing for a period during the rotation of the motor. Specifically, for example, the low-side predriver 8 can place two of the transistors M4 to M6 in the energizable state for a certain period by transmitting an energization pulse to the two transistors. By transmitting the energization pulse to the transistors, an inductive voltage occurring in the motor M can be converted into a current. A duration of the energization pulse can be optionally set, insofar as the rotation of the motor M does not stop.

Next, the operation of the motor control device 10 will be described. At the startup of the motor M, the motor M may be at a stop or rotated by an external force. The motor M may be rotated forward or clockwise, or reversely or counterclockwise. For example, to rotate a fan with the motor M, the motor M may be rotated forward or reversely depending on a direction of disturbance such as blowing wind to the fan. A certain rotational direction will be referred to as forward, and a rotation direction reverse to the forward rotation will be referred to as reverse. That is, the rotation of the motor M may be forward or reverse.

In order to rotate the motor M in a correct direction, it is necessary to correctly recognize the current rotational direction of the motor M being in rotation. In view of this, the following will describe a detecting method, with a simple configuration, for the rotational direction of the motor M with only one hall element and one hall signal.

First, the low-side predriver 8 sets, for example, the transistors M4 and M6 of the transistors M1 to M6 in the energizable state for a certain period by transmitting the energization pulse to the transistors M4 and M6 during the rotation of the motor M. In this case, the rotational-direction detector 5 detects the rotational direction of the motor M in accordance with the U-phase hall detection signal Hall and the phase current detection signal Rotate. To be described below, a combination of the two transistors M4 and M6 and timing at which the two transistors M4 and M6 are placed in the energizable state, that is, timing at which the energization pulse is transmitted (electrical angles of 90° and 270°), are determined to allow a difference between the inductive voltages occurring on the coils corresponding to the two transistors M4 and M6 to be maximal.

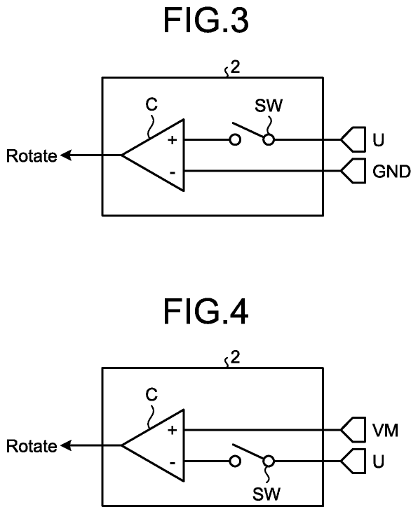

FIG. 3 is a diagram illustrating the configuration of the phase-current detector circuit 2 on a low potential side in the first embodiment. The low potential side phase-current detector circuit 2 includes a comparator C and a switching element SW. When the switching element SW is closed in response to an command signal from the output-waveform generator 6, the comparator C compares the U-phase voltage with a ground voltage (0 V). When the U-phase voltage is greater than the ground voltage, the comparator C outputs a HIGH signal as the phase current detection signal Rotate. The use of the U phase is exemplary, and the V phase or the W phase may be used. In this case, wiring may be changed according to a phase shift.

Although not included in the first embodiment, the phase-current detector circuit 2 on a high potential side is described. FIG. 4 is a diagram illustrating the configuration of the phase-current detector circuit 2 on a high potential side in the first embodiment. The high potential side phase-current detector circuit 2 includes the comparator C and the switching element SW. When the switching element SW is closed in response to a command signal from the output-waveform generator 6, the comparator C compares a voltage to be supplied from the motor power applying terminal VM with the U-phase voltage. When the voltage to be supplied from the motor power applying terminal VM is greater than the U-phase voltage, the comparator C outputs a HIGH signal as the phase current detection signal Rotate. It is possible to detect the rotational direction of the motor M with the phase-current detector circuit 2 on a high potential side as illustrated in FIG. 4, instead of the phase-current detector circuit 2 on a low potential side as illustrated in FIG. 3.

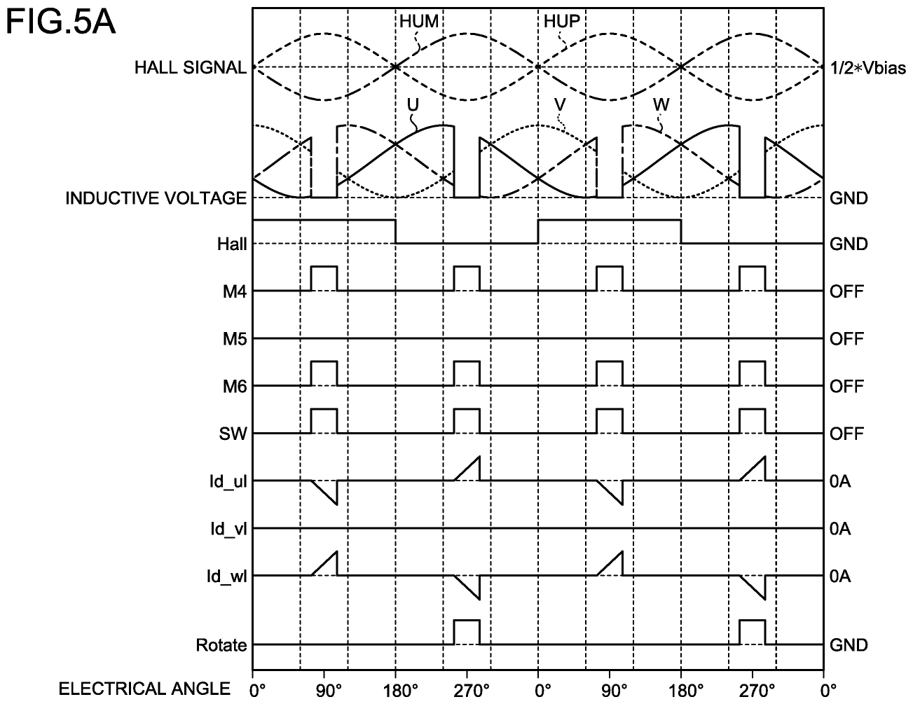

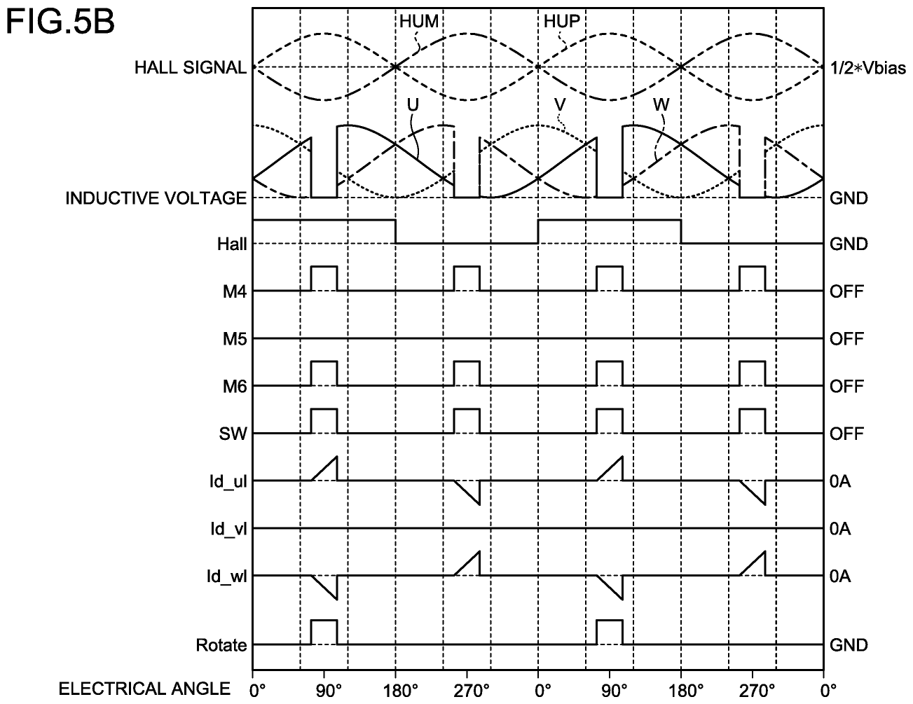

Next, a variation in each signal during the forward rotation of the motor in the first embodiment will be described with reference to FIG. 5A. FIG. 5A is a timing chart illustrating a variation in each signal during the forward rotation of the motor in the first embodiment. Throughout the embodiments, it is assumed that the motor M be rotated forward by an external force such as wind blowing to the fan connected to the motor M.

FIG. 5A shows, from above, hall signals HUP and HUM (½*V bias indicates a half value of a bias voltage), three-phase (U phase, V phase, and W phase) inductive voltages, U-phase hall detection signal Hall, ON and OFF of the transistors M4, M5, and M6, ON and OFF of the switching element SW of the phase-current detector circuit 2 on the low potential side, a drain current Id_ul of the transistor M4, a drain current Id_vl of the transistor M5, a drain current Id_wl of the transistor M6, and HIGH and LOW of the phase current detection signal Rotate.

As for Id_ul, Id_vl, and Id_wl, a downward direction in FIG. 2 corresponds to a positive direction of the current. The horizontal axis represents progress of time in rightward direction, and is expressed by electrical angle.

The U-phase hall detection signal Hall turns to HIGH in the electrical angle range of 0° to 180°, and turns to LOW in an electrical angle of 180° to 360°.

The transistors M4 and M6 are placed in the energizable state at electrical angles of 90° and 270° by the energization pulse from the low-side predriver 8. Similarly, the switching element SW of the phase-current detector circuit 2 on the low potential side (hereinafter, also simply referred to as phase-current detector circuit 2) turns ON at electrical angles of 90° and 270°, and thus, the phase-current detector circuit 2 becomes operable.

The transistors M4 and M6 are placed in the energizable state at an electrical angle of 90°. The W-phase inductive voltage is higher than the U-phase inductive voltage, so that a current flows into Id_ul in a negative direction, and a current flows into Id_wl in the positive direction, forming such a current path. Since the U-phase voltage is less than the ground voltage, the phase-current detector circuit 2 does not output a HIGH signal as the phase current detection signal Rotate.

At an electrical angle of 270°, the transistors M4 and M6 are placed in the energizable state. The W-phase inductive voltage is lower than the U-phase inductive voltage, thus, the current flows into Id_ul in the positive direction, and the current flows into the Id_wl in the negative direction, forming such a current path. Since the U-phase voltage is greater than the ground voltage, the phase-current detector circuit 2 outputs a HIGH signal as the phase current detection signal Rotate.

Next, a variation in each signal during the reverse rotation of the motor will be described with reference to FIG. 5B. FIG. 5B is a timing chart illustrating a variation in each signal during the reverse rotation of the motor in the first embodiment. The items on the vertical axis and the horizontal axis of FIG. 5B are the same as those of FIG. 5A. The motor M is reversely rotated by an external force.

As with FIG. 5A, the transistors M4 and M6 are placed in the energizable state at electrical angles of 90° and 270° by the energization pulse from the low-side predriver 8. Similarly, the switching element SW of the phase-current detector circuit 2 is turned ON at electrical angles of 90° and 270°, and thus the phase-current detector circuit 2 becomes operable

At the electrical angle of 90°, the transistors M4 and M6 are placed in the energizable state. Since the W-phase inductive voltage is lower than the U-phase inductive voltage, the current flows into Id_ul in the positive direction, and the current flows into Id_wl in the negative direction, forming such a current path. Since the U-phase voltage is greater than the ground voltage, the phase-current detector circuit 2 outputs a HIGH signal as the phase current detection signal Rotate.

At the electrical angle of 270°, the transistors M4 and M6 are placed in the energizable state. The W-phase inductive voltage is higher than the U-phase inductive voltage, so that the current flows into Id_ul in the negative direction, and the current flows into Id_wl in the positive direction, forming such a current path. The U-phase voltage is less than the ground voltage, therefore, the phase-current detector circuit 2 does not output a HIGH signal as the phase current detection signal Rotate.

That is, the rotational-direction detector 5 can determine that the motor M is rotated forward, when at the electrical angle of 90°, the U-phase hall detection signal Hall is HIGH, and the phase current detection signal (Rotate) is LOW, and at the electrical angle of 270° the U-phase hall detection signal Hall is LOW, and the phase current detection signal Rotate is HIGH.

The rotational-direction detector 5 can also determine that the motor M is rotated reversely, when at the electrical angle of 90°, the U-phase hall detection signal Hall is HIGH, and the phase current detection signal Rotate is HIGH, and at the electrical angle of 270°, the U-phase hall detection signal Hall is LOW and the phase current detection signal Rotate is LOW.

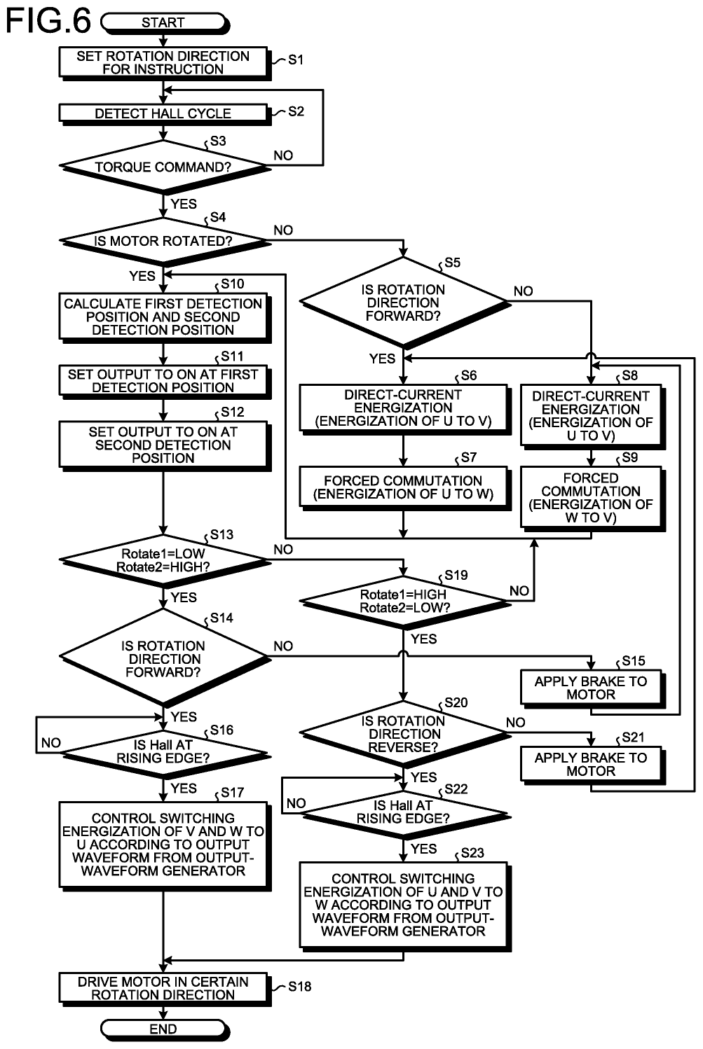

Next, the operation of the motor control device 10 according to the first embodiment will be described with reference to FIG. 6. FIG. 6 is a flowchart illustrating the operation of the motor control device 10 according to the first embodiment. As for the operation not directly involving the features of the first embodiment or the operation of which a subject is unambiguously determined from the elements in FIG. 1 and FIG. 2, the motor control device 10 is assumed to be the one that performs such operation.

In S1, the motor control device 10 sets the rotational direction of the motor M for instruction on the basis of pre-stored information and a user input. The rotational direction can be forward or reverse. In S2, the motor control device 10 detects a hall cycle i.e., the cycle of the hall signal.

In S3, the motor control device 10 determines whether or not to have received a torque command for operating the motor M. In the case of YES, the motor control device 10 proceeds to S4, and in the case of NO, it returns to S2.

In S4, the motor control device 10 determines whether or not the motor M is rotated, on the basis of a result of the detection of the rotation-speed detector 3. In the case of YES, the motor control device 10 proceeds to S10, and in the case of NO, it proceeds to S5. In S5, the motor control device 10 determines whether or not the rotational direction is forward.

In the case of YES in S5, in order to rotate the motor M forward, the motor control device 10 controls the output-waveform generator 6, the high-side predriver 7, and the low-side predriver 8 to execute direct-current excitation (S6) for energization from the U Phase to V Phase, or forced commutation (S7) for energization from the U Phase to W Phase, and proceeds to S10.

In the case of NO in S5, in order to reversely rotate the motor M, the motor control device 10 controls the output-waveform generator 6, the high-side predriver 7, and the low-side predriver 8 to execute direct-current excitation (S8) from U Phase to V Phase or forced commutation (S9) from W Phase to V Phase, and proceeds to S10.

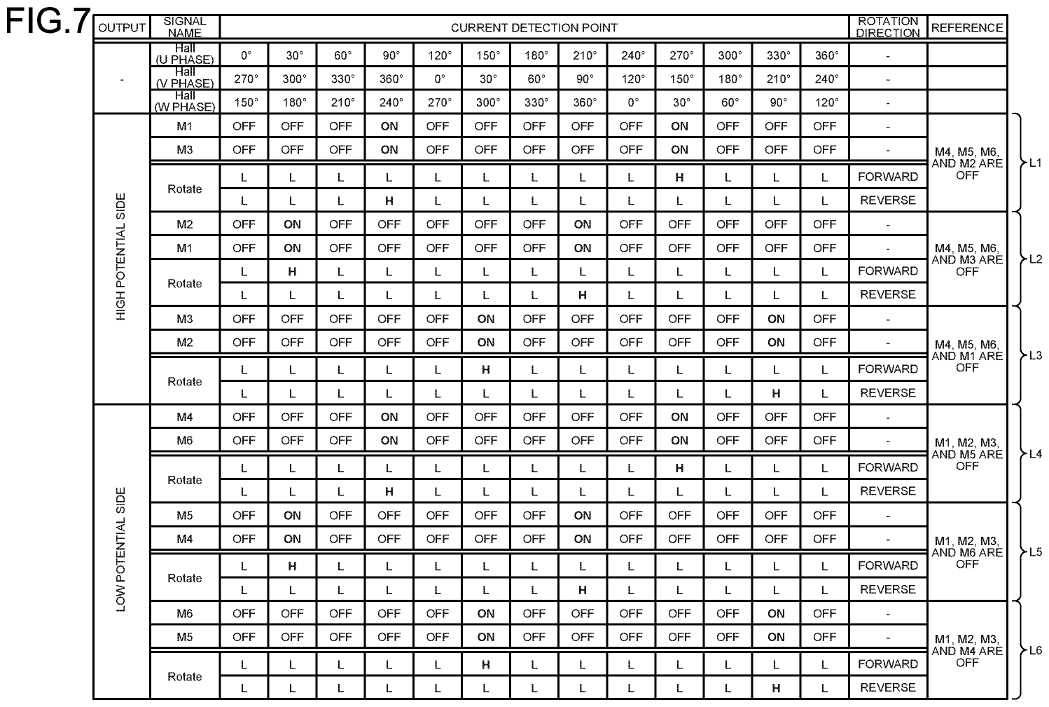

In S10, the output-waveform generator 6 calculates a first detection position and a second detection position. Herein, the first detection position and the second detection position represent electrical angles at which the rotational direction of the motor M is detected, and are set to 90° and 270°, respectively, for example. The first detection position and the second detection position can be determined, for example, on the basis of information as illustrated in FIG. 7.

In S11, the output of the low-side predriver 8 at the first detection position is set to ON. Thereby, at an electrical angle of 90°, for example, the transistors M4 and M6 are placed in the energizable state by the energization pulse from the low-side predriver 8.

In S12, the output of the low-side predriver 8 at the second detection position is set to ON. Thereby, at an electrical angle of 270°, for example, the transistors M4 and M6 are placed in the energizable state by the energization pulse from the low-side predriver 8.

In S13, the rotational-direction detector 5 determines whether or not a phase current detection signal Rotate1 in the first detection position is LOW, and a phase current detection signal Rotate2 in the second detection position is HIGH, that is, the rotational direction of the motor M is forward. In the case of YES, the motor control device 10 proceeds to S14, and in the case of NO, it proceeds to S19.

In S14, the motor control device 10 determines whether or not the rotational direction is forward. In the case of YES, the motor control device 10 proceeds to S16, and in the case of NO, it proceeds to S15.

In S15, the motor control device 10 applies brakes to the motor M, for example, by tuning on the low potential side of the U phase, the V phase, and the W phase, and returns to S8.

In S19, the rotational-direction detector 5 determines whether or not the phase current detection signal Rotate1 in the first detection position is HIGH, and the phase current detection signal Rotate2 in the second detection position is LOW, that is, the rotational direction of the motor M is reverse. In the case of YES, the motor control device 10 proceeds to S20, and in the case of NO, it returns to S10.

In S20, the motor control device 10 determines whether or not the rotational direction is reverse. In the case of YES, the motor control device 10 proceeds to S22, and in the case of NO, it proceeds to S21.

In S21, the motor control device 10 applies brakes to the motor M, for example, by turning on the low potential side of the U phase, the V phase, and the W phase, and returns to S6.

In S16, the motor control device 10 determines whether or not the U-phase hall detection signal Hall is currently at a rising edge (that is, electrical angle 0°). In the case of YES, the motor control device 10 proceeds to S17, and in the case of NO, it repeats S16.

In S17, the motor control device 10 controls the switching from the V Phase and the W Phase to the U Phase for energization according to the output waveform generated by the output-waveform generator 6, and proceeds to S18.

In S22, the motor control device 10 determines whether or not the U-phase hall detection signal Hall is currently at a rising edge. In the case of YES, the motor control device 10 proceeds to S23, and in the case of NO, it repeats S22.

In S23, the motor control device 10 controls the switching from the U Phase and the V Phase to the W Phase for energization according to the output waveform generated by the output-waveform generator 6, and returns to S18. In S18, the motor control device 10 drives the motor M in a certain rotational direction.

Thus, the motor control device 10 of the first embodiment with a simple configuration can detect the rotational direction of the motor M having only one hall signal. Specifically, during the rotation of the motor M the motor control device 10 transmits the energization pulse to one or more transistors of the transistors M1 to M6, placing the transistors in the energizable state for a certain period. Thereby, the motor control device 10 can detect the rotational direction of the motor M in accordance with the U-phase hall detection signal Hall and the phase current detection signal Rotate.

Conventionally, there is a method for detecting the rotational direction of the brushless motor with only one hall element, in accordance with one hall signal and a result of comparison between the two-phase inductive voltages occurring along with the rotation of the multi-phase brushless motor, for example. However, such a method needs to deal with a great inductive voltage occurring from the rotation of the brushless motor, and thus, requires an element such as a comparator in larger size with higher pressure resistance for comparing the two-phase inductive voltages. There is hence a room for improvement in terms of the price or the size of the parts and elements. In contrast, the motor control device 10 of the first embodiment does not require the comparator C (refer to FIG. 3 and FIG. 4) of the phase-current detector circuit 2 to be in larger size with higher pressure resistance, greatly improving in terms of the price or the size of the parts and elements.

In addition, owing to the combination of the two transistors M4 and M6, a difference between the inductive voltages occurring on the coils corresponding to the transistors M4 and M6 becomes maximal at the timing at which the energization pulse is transmitted at electrical angles of 90° and 270°. This can increase the absolute value of the current flowing through each of Id_ul and Id_wl (refer to FIG. 5A and FIG. 5B), and reduce the influence of noise.

Upon transmission of the energization pulse, the current flows into the transistors, but the current does not flow into the diodes. This can reduce the influence of a voltage drop, and improve detecting performance.

The transistors to which the energization pulse is transmitted are not limited to M4 and M6. FIG. 7 is a relationship diagram of signal detection in the first embodiment. In FIG. 7, a row L4 shows that the transistors M4 and M6 are selected as the transistors to which the energization pulse is transmitted. As illustrated in a row L5, for example, the transistors M4 and M5 may be selected as the transistors to which the energization pulse is transmitted. In this case, at set current detection points (the electrical angles for detecting the rotational direction of the motor M) of 30° and 210°, the same results are obtained as when the transistors M4 and M6 are selected, and the current detection points are set to 90° and 270°. In addition, as illustrated in rows L6 and L1 to L3, other combinations of two transistors may be selected as transistors to which the energization pulse is transmitted. In this case the wiring is changed as necessary.

### Second Embodiment

Next, the motor control device 10 of a second embodiment will be described. The description of the same features as those of the first embodiment will be appropriately omitted. In the second embodiment, as illustrated in the row L5 of FIG. 7, the transistors M4 and M5 are selected as the transistors to which the energization pulse is transmitted. For the purpose of comparison with the first embodiment, the current detection points are set not to 30° and 210° but to 90° and 270°, as in the first embodiment.

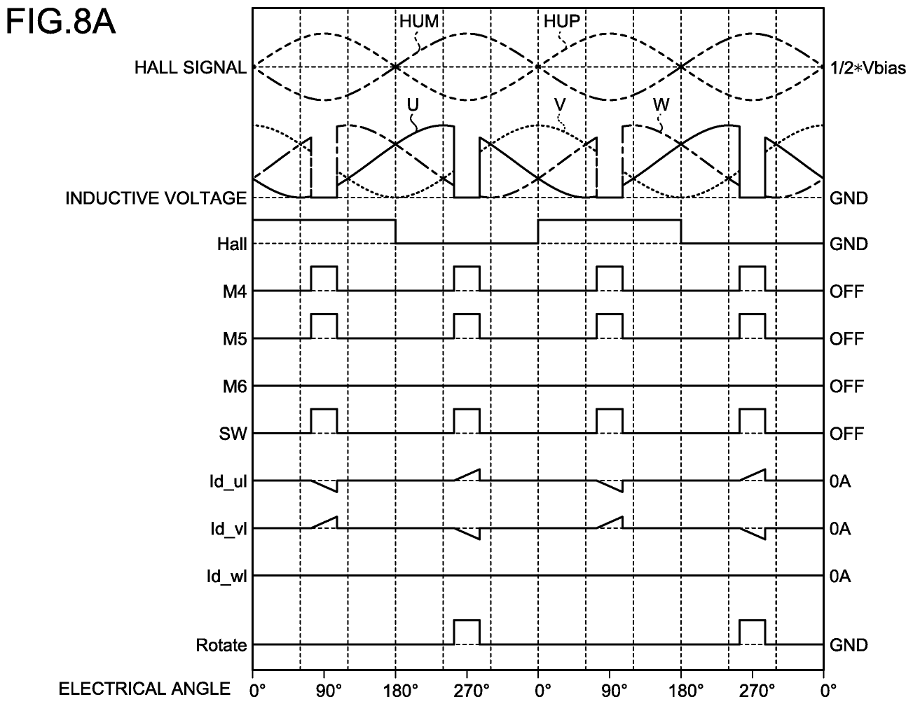

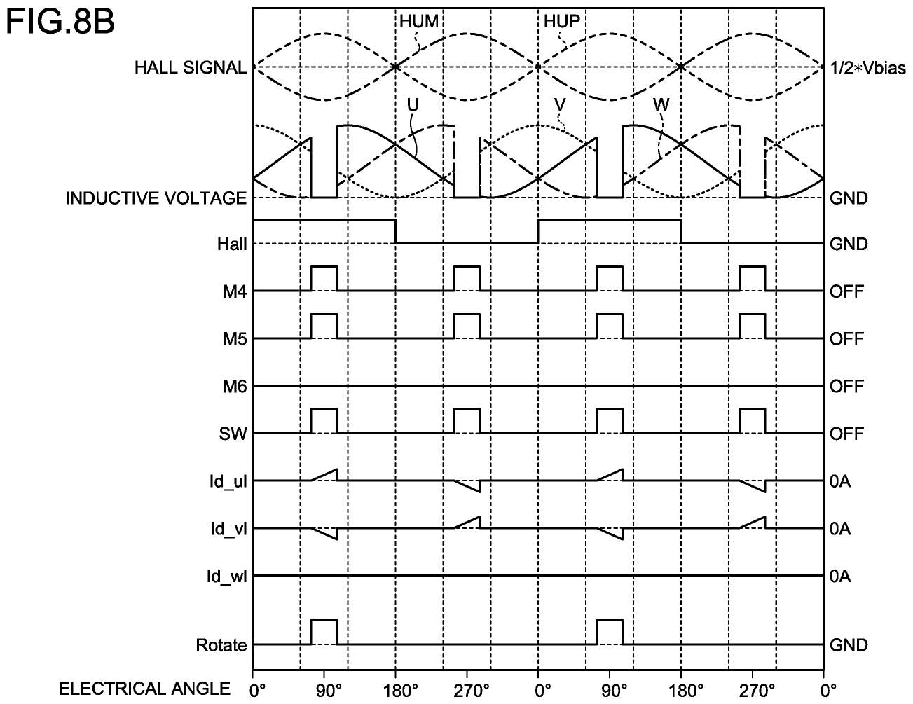

FIG. 8A is a timing chart illustrating a variation in each signal during the forward rotation of the motor in the second embodiment. The motor M is rotated forward by an external force. The items on the vertical axis and the horizontal axis of FIG. 8A are the same as those in FIG. 5A.

The U-phase hall detection signal Hall is HIGH in the electrical angle range of 0° to 180°, and is LOW in the electrical angle range of 180° to 360°.

The transistors M4 and M5 are placed in the energizable state at electrical angles of 90° and 270° by the energization pulse from the low-side predriver 8. Similarly, the switching element SW of the phase-current detector circuit 2 is turned ON at electrical angles of 90° and 270°, and thus, the phase-current detector circuit 2 becomes operable.

At an electrical angle of 90°, the transistors M4 and M5 are placed in the energizable state. The W-phase inductive voltage is higher than the U-phase inductive voltage, so that the current flows into Id_ul in the negative direction, and the current flows into Id_vl in the positive direction. Thus, the U-phase voltage is less than the ground voltage, so that the phase-current detector circuit 2 does not output the HIGH signal as the phase current detection signal Rotate.

At an electrical angle of 270°, the transistors M4 and M5 are placed in the energizable state. The W-phase inductive voltage is lower than the U-phase inductive voltage, so that the current flows into Id_ul in the positive direction, and the current into Id_vl flows in the negative direction. Thus, the U-phase voltage is greater than the ground voltage, so that the phase-current detector circuit 2 outputs the HIGH signal as the phase current detection signal Rotate.

Next, a variation in each signal during the reverse rotation of the motor in the second embodiment will be described with reference to FIG. 8B. FIG. 8B is a timing chart illustrating a variation in each signal during the reverse rotation of the motor in the second embodiment. The motor M is rotated reversely by an external force. The items on the vertical axis and the horizontal axis of FIG. 8B are the same as those of FIG. 8A.

As with FIG. 8A, the transistors M4 and M5 are placed in the energizable state at electrical angles of 90° and 270° by the energization pulse from the low-side predriver 8. Similarly, the switching element SW of the phase-current detector circuit 2 is turned ON at electrical angles of 90° and 270°, and thus, the phase-current detector circuit 2 becomes operable.

At an electrical angle of 90°, the transistors M4 and M5 are placed in the energizable state. Since the W-phase inductive voltage is lower than the U-phase inductive voltage, the current flows into Id_ul in the positive direction, and the current flows into Id_vl in the negative direction. Thus, the U-phase voltage is greater than the ground voltage, so that the phase-current detector circuit 2 outputs the HIGH signal as the phase current detection signal Rotate.

At an electrical angle of 270°, the transistors M4 and M6 are placed in the energizable state. Since the W-phase inductive voltage is higher the U-phase inductive voltage, the current flows into Id_ul in the negative direction, and the current flows into Id_vl in the positive direction. Thus, the U-phase voltage is less than the ground voltage, so that the phase-current detector circuit 2 does not output a HIGH signal as the phase current detection signal Rotate.

That is, the rotational-direction detector 5 can determine that the motor M is rotated forward, when at the electrical angle of 90°, the U-phase hall detection signal Hall is HIGH, and the phase current detection signal Rotate is LOW, and at the electrical angle of 270°, the U-phase hall detection signal Hall is LOW, and the phase current detection signal Rotate is HIGH.

In addition, the rotational-direction detector 5 can determine that the motor M is rotated reversely, when at the electrical angle of 90°, the U-phase hall detection signal Hall is HIGH, and the phase current detection signal Rotate is HIGH, and at the electrical angle of 270°, the U-phase hall detection signal Hall is LOW, and the phase current detection signal Rotate is LOW.

Thus, the motor control device 10 of the second embodiment can detect the rotational direction of the motor M using the combination of the transistors M4 and M5 at the transmission timing of the energization pulse at the electrical angles 90° and 270°. Bu using the combination of the transistors M4 and M5 (refer to FIG. 7), setting the transmission timing of the energization pulse to the electrical angles of 30° and 210° makes it possible to increase, to maximum, a difference between the inductive voltages occurring on the coils corresponding to the transistors M4 and M5, leading to increasing the absolute value of the current flowing through each of Id_ul and Id_vl and reducing the influence of noise, as with the first embodiment.

### Third Embodiment

Next, the motor control device 10 of a third embodiment will be described. The description of the features as those of the first embodiment will be appropriately omitted. The third embodiment describes an example of setting one transistor to be a transmission destination of the energization pulse. The rotational-direction detector 5 detects the rotational direction of the motor M from the U-phase hall detection signal Hall and the phase current detection signal Rotate at timing at which the transistor is placed in the energizable state.

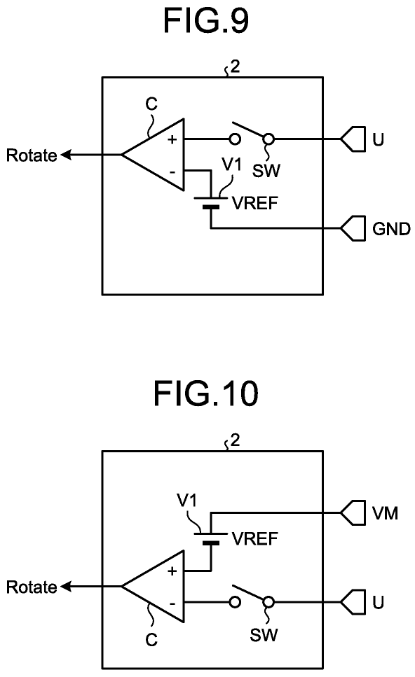

FIG. 9 is a diagram illustrating the configuration of the phase-current detector circuit 2 on a low potential side in the third embodiment. The phase-current detector circuit 2 on a low potential side includes a comparator C, a switching element SW, and a reference voltage generator circuit V1 that generates a reference voltage VREF. When the switching element SW is closed in response to a command signal from the output-waveform generator 6, the comparator C compares the U-phase voltage with the reference voltage VREF. When the U-phase voltage is greater than the reference voltage VREF, the comparator C outputs a HIGH signal as the phase current detection signal Rotate. The use of the U phase is merely exemplary, and the V phase or the W phase may be also used. In this case the wiring is changed depending on a phase shift.

Although not included in the third embodiment, the configuration of a phase-current detector circuit 2 on a high potential side will be described. FIG. 10 is a diagram illustrating the configuration of the phase-current detector circuit 2 on a high potential side in the third embodiment. The phase-current detector circuit 2 on a high potential side includes a comparator C, a switching element SW, and a reference voltage generator circuit V1 that generates the reference voltage VREF. When the switching element SW is closed in response to the command signal from the output-waveform generator 6, the comparator C compares the voltage to be supplied from the motor power applying terminal VM with the U-phase voltage. When the voltage to be supplied from the motor power applying terminal VM is greater than the U-phase voltage, the comparator C outputs a HIGH signal as the phase current detection signal Rotate. It is possible to detect the rotational direction of the motor M, using the phase-current detector circuit 2 on a high potential side illustrated in FIG. 10, instead of the phase-current detector circuit 2 on a low potential side illustrated in FIG. 9.

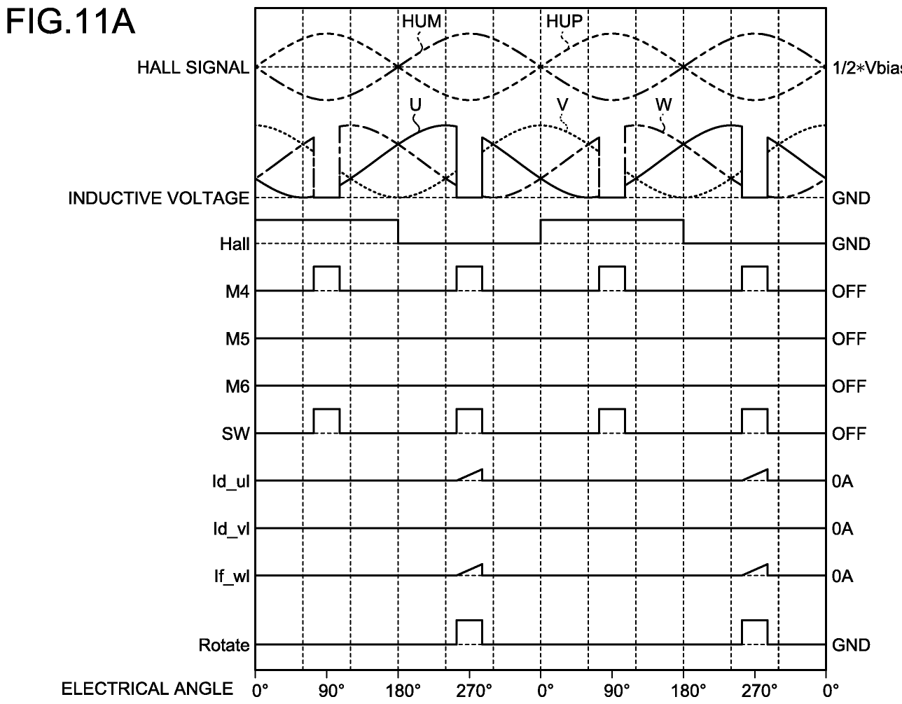

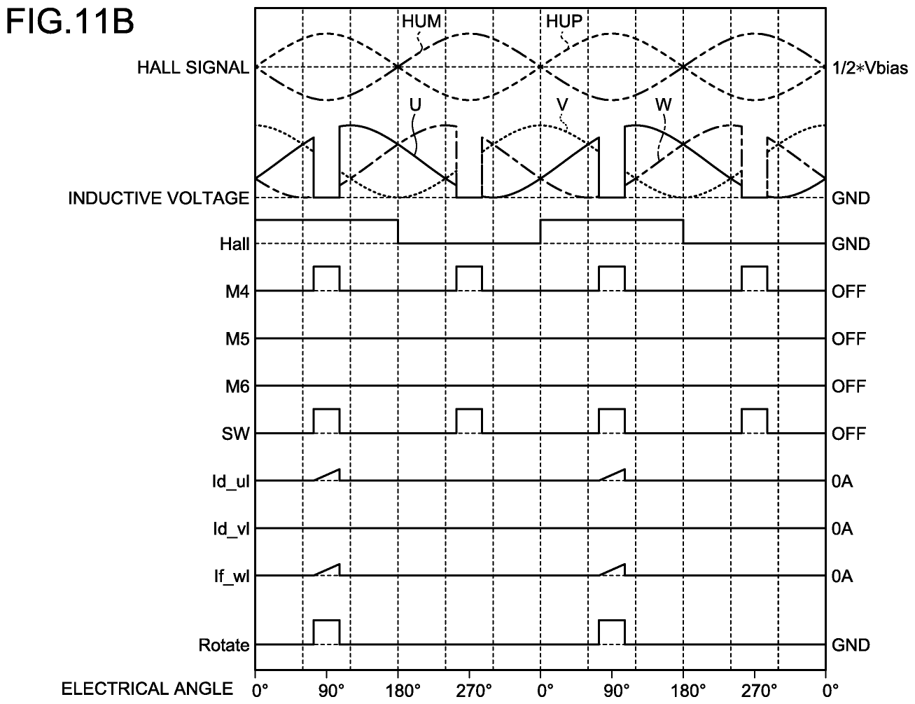

FIG. 11A is a timing chart illustrating a variation in each signal during the forward rotation of the motor in the third embodiment. The transistor M4 is selected as the transistor to which the energization pulse is transmitted. The motor M is rotated forward by an external force. The items on the vertical axis and the horizontal axis of FIG. 11A are the same as those in FIG. 5A, except for that the vertical axis shows If_wl in place of Id_wl, that is, the current flows into the diode D6 of FIG. 2 (upward direction in FIG. 2 corresponds to the positive direction).

In the electrical angle range of 0° to 180°, the U-phase hall detection signal Hall is HIGH, and is LOW in the electrical angle range of 180° to 360°.

The transistor M4 is placed in the energizable state at electrical angles of 90° and 270° by the energization pulse from the low-side predriver 8. Similarly, the switching element SW of the phase-current detector circuit 2 is turned ON at electrical angles of 90° and 270°, and thus the phase-current detector circuit 2 becomes operable.

The transistor M4 is placed in the energizable state at an electrical angle of 90°. Although the U-phase voltage (the inductive voltage) is less than the W-phase voltage (the inductive voltage), the diodes D4 to D6 do not allow the current to flow downward in FIG. 2, forming no current path. Thus, no current flows into any of Id_ul, Id_vl, and If_wl, so that the phase-current detector circuit 2 does not output a HIGH signal as the phase current detection signal Rotate.

The transistor M4 is placed in the energizable state at an electrical angle of 270°. The U-phase voltage (the inductive voltage) is greater than the W-phase voltage (the inductive voltage). Thus, the current flows into both of Id_ul and If_wl in the positive direction, and the phase-current detector circuit 2 outputs a HIGH signal as the phase current detection signal Rotate.

Next, a variation in each signal during the reverse rotation of the motor in the third embodiment will be described with reference to FIG. 11B. FIG. 11B is a timing chart illustrating a variation in each signal during the reverse rotation of the motor in the third embodiment. The motor M is rotated reversely by an external force. The items on the vertical axis and the horizontal axis in FIG. 11B are the same as those in FIG. 11A.

As with FIG. 11A, the transistor M4 is in the energizable state at electrical angles of 90° and 270° by the energization pulse from the low-side predriver 8. Similarly, the switching element SW of the phase-current detector circuit 2 is set to ON at electrical angles of 90° and 270°, and thus the phase-current detector circuit 2 becomes operable.

The U-phase hall detection signal Hall is HIGH in the electrical angle range of 0° to 180°, and is LOW in the electrical angle range of 180° to 360°.

The transistor M4 is placed in the energizable state at the electrical angle of 90°. The U-phase voltage (the inductive voltage) is greater than the W-phase voltage (the inductive voltage). That is, the current flows into both of Id_ul and If_wl in the positive direction, and the phase-current detector circuit 2 outputs a HIGH signal as the phase current detection signal Rotate.

At the electrical angle of 270°, the transistor M4 is placed in the energizable state. The U-phase voltage (the inductive voltage) is less than the W-phase voltage (the inductive voltage), however, the diodes D4 to D6 do not allow the current to flow downward in FIG. 2, forming no current path. Thus, no current flows into any of Id_ul, Id_vl, and If_wl, and the phase-current detector circuit 2 does not output a HIGH signal as the phase current detection signal Rotate.

As described above, the rotational-direction detector 5 can determine that the motor M is rotated forward, when at the electrical angle of 90°, the U-phase hall detection signal Hall is HIGH and the phase current detection signal Rotate is LOW, and at the electrical angle of 270°, the U-phase hall detection signal Hall is LOW and the phase current detection signal Rotate is HIGH.

In addition, the rotational-direction detector 5 can determine that the motor M is rotated reversely, when at the electrical angle of 90°, the U-phase hall detection signal Hall is HIGH and the phase current detection signal Rotate is HIGH, and at the electrical angle of 270°, the U-phase hall detection signal Hall is LOW and the phase current detection signal Rotate is LOW.

As described above, the motor control device 10 of the third embodiment can detect the rotational direction of the motor M with only one transistor to which the energization pulse is transmitted.

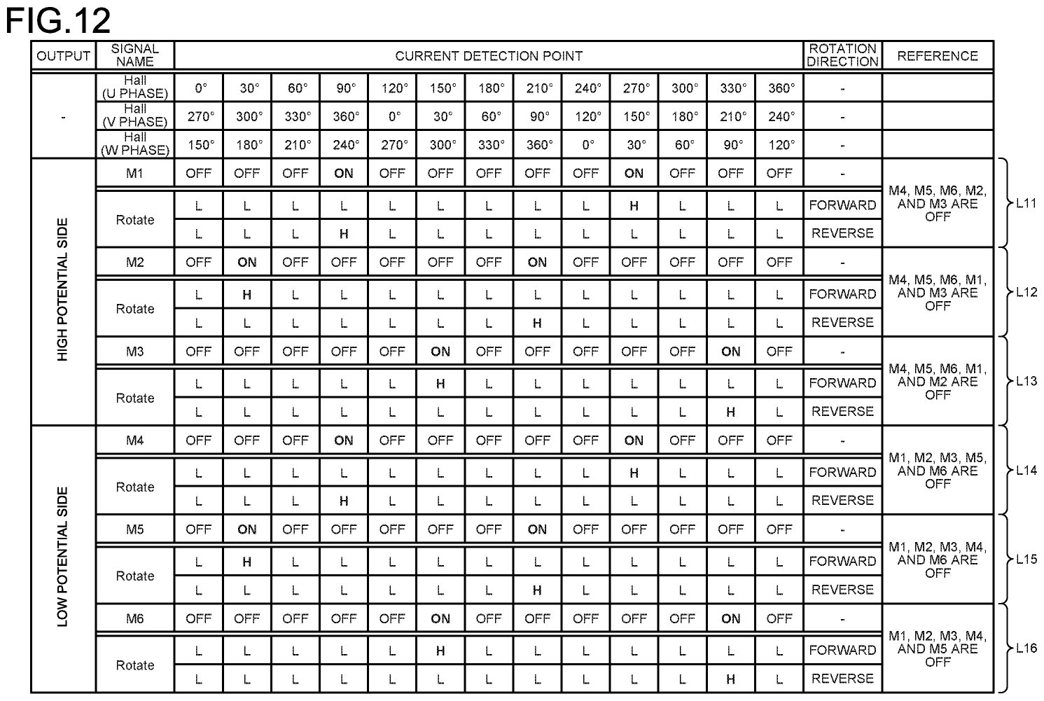

The transistor to which the energization pulse is transmitted is not limited to M4. FIG. 12 is a detection relationship diagram in the third embodiment.

As illustrated in FIG. 12, in a row L14, the transistor M4 is selected as the transistor to which the energization pulse is transmitted. In addition, for example, as illustrated in a row L15, the transistor M5 may be selected as the transistor to which the energization pulse is transmitted. In this case, the current detection points may be set to 30° and 210°, for example. As illustrated in a row L16 or rows L11 to L13, other transistors may be set as the transistors to which the energization pulse is transmitted (as necessary, the wiring is changed).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The first to third embodiments has described the example of the three-phase coils of the motor M, but it is not limited thereto. Four or more phase coils can be adopted.

In addition, in use of not the low potential side but the high potential side of the power device 9 for detecting the rotational direction of the motor M, Id_uh, Id_vh, Id_wh, and If_wh of FIG. 1 are assumed to correspond to Id_ul, Id_vl, Id_wl, and If_wl of FIG. 2.

What is claimed is:

1. A motor control device that controls a brushless motor including a rotor with a magnet, and a stator including multi-phase wound coils, the device comprising:
a power device that includes a plurality of transistors, and supplies power to the brushless motor;
a hall-signal detector that detects a hall signal from one hall element of the brushless motor;
a power-device controller that sets at least one of the transistors in an energizable state for a certain period at certain timing during rotation of the brushless motor;
a phase-current detector that detects a phase current flowing through the at least one transistor in the energizable state; and
a rotational-direction detector that detects a rotational direction of the brushless motor, in accordance with the hall signal and the detected phase current at timing in the energizable state of the at least one transistor.

2. The motor control device according to claim 1, wherein
the power-device controller sets two of the transistors in the energizable state for a certain period at certain timing during the rotation of the brushless motor, and
the rotational-direction detector detects the rotational direction of the brushless motor, in accordance with the hall signal and the detected phase current at timing in the energizable state of the two transistors.

3. The motor control device according to claim 2, wherein
a combination of the two transistors and the timing at which the two transistors are set in the energizable state are determined so as to allow a difference between inductive voltages occurring on the coils of the two transistors to be maximal.

4. The motor control device according to claim 1, wherein
the power device includes diodes corresponding to the transistors.

5. The motor control device according to claim 4, wherein
the power-device controller sets one of the transistors in the energizable state for a certain period at certain timing during the rotation of the brushless motor, and
the rotational-direction detector detects the rotational direction of the brushless motor, in accordance with the hall signal detected by the hall-signal detector and the phase current detected by the phase-current detector at timing in the energizable state of the one transistor, the phase current having passed through any of the diodes.

6. A motor control method to be performed by a motor control device that controls a brushless motor including a rotor with a magnet, and a stator including multi-phase wound coils, the motor control device comprising: a power device that includes a plurality of transistors, and supplies power to the brushless motor; a hall-signal detector that detects a hall signal from one hall element of the brushless motor; and a power-device controller that sets at least one of the transistors in an energizable state for a certain period at certain timing during rotation of the brushless motor, the method comprising:
detecting a phase current flowing through the at least one transistor in the energizable state; and
detecting a rotational direction of the brushless motor, in accordance with the hall signal and the detected phase current at timing in the energizable state of the at least one transistor.

7. The motor control method according to claim 6, further comprising
setting two of the transistors in the energizable state for a certain period at certain timing during the rotation of the brushless motor, wherein
detecting the rotational direction includes detecting the rotational direction of the brushless motor, in accordance with the hall signal and the detected phase current at timing at which the two transistors are set in the energizable state.

8. The motor control method according to claim 7, wherein
a combination of the two transistors and the timing at which the two transistors are set in the energizable state are determined so as to allow a difference between inductive voltages occurring on the coils of the two transistors to be maximal.

9. The motor control method according to claim 6, wherein
the power device includes diodes corresponding to the transistors.

10. The motor control method according to claim 9, further comprising
setting one of the transistors in the energizable state for a certain period at certain timing during the rotation of the brushless motor, wherein
detecting the rotational direction includes detecting the rotational direction of the brushless motor, in accordance with the hall signal detected in the hall-signal detecting and the phase current detected in the phase-current detecting at timing in the energizable state of the one transistor, the phase current having passed through any of the diodes.
